(19) United States
(12) Patent Application Publication
(10) Pub. No.: US 2013/0145282 A1
(43) Pub. Date: Jun. 6, 2013

(54) SYSTEMS AND METHODS FOR SOCIAL-EVENT BASED SHARING

(71) Applicant: Zhenzhen ZHAO, Evry (FR)

(72) Inventor: Zhenzhen ZHAO, Evry (FR)

(21) Appl. No.: 13/310,877

(22) Filed: Dec. 5, 2011

(51) Int. Cl. G06F 3/01

(52) U.S. Cl. 715/751

(57) ABSTRACT

A computer implemented method for providing user-event based social information over a network is provided. The method includes receiving by the computer, event information related to an operator-defined event comprising an event date and at least one of an event description and an event location, receiving by the computer, a selection of a publication level associated with the operator-defined event, and causing at least a portion of the event information to be displayed within at least one electronic calendar associated with at least one user based on the selected publication level.

### FIELD OF THE DISCLOSURE

The present disclosure relates to network based user interfaces, and more particularly, to user interfaces configured to provide sharing of user-event based social information over a network.

### BACKGROUND OF THE DISCLOSURE

The social web has changed the way users share and interact with content. It has taken content, such as, for example, photos, videos and bookmarks, from users' desktops to online sites for sharing. This uploaded content is often associated with users' day-to-day activities.

Social networking sites are often thought of as places to catch up on personal information and current activities of friends, acquaintances, and colleagues. Available services have enabled consumers to stay connected to their favorite social networks for viewing user-generated content, for example, users create, upload, and interact with content by sharing, rating and commenting. In this evolving landscape, social networking players are constantly looking for methods to provide innovative features to keep users linked to their networks.

However, many users have had a similar feeling when looking at certain photos of their friends on, for example, Facebook, questioning themselves as to why they were not present at the event and/or wishing they could have known about the event in advance so that they could have been there. Research has demonstrated that much of the time-based information posted on social sites, for example, Twitter, was in reference to what users were doing at the current time, (i.e. “in a meeting for the next hour”), however, it is believed that many users are also willing to share future plans and events.

Research related to online social networking sites has shown that users appreciate the communication channels that social sites provide to perform a variety of tasks, including socializing and coordinating based on events.

Commercial platforms like Going.com (now part of Patch.com), Upcoming.yahoo.com, and Eventful.com may provide a convenient way for users to find professionally coordinated and/or sponsored events to attend. These sites are focused on leveraging social networks to help users find something to do and meet other like-minded people.

Events on these sites typically involve a group of people rather than a single individual, and the events are typically “official” events, comprised of concerts, festivals, sports, arts etc. However, such systems do not provide a way for an everyday user to define day-to-day activities and invite friends, schoolmates, family, and/or colleagues. In other words, these sites do not enable the social aspects of the event to be shared with people the user would like to share such events with.

“R-U-In?” enables on-the-fly community formation around real-time interests and management of ephemeral communities. This site can create mashup applications that combine network capabilities with web-based services enabling the concept of real-time social networking through which one can find, on-demand, like-minded people who are potentially interested in a common activity. These people can be filtered by their current location, availability, and interest attributes.

Similarly, Plancast.com allows sharing and socializing around plans associated with a predefined event. Users can subscribe to certain peoples plans and certain event types. Events are categorized into nine types, i.e., technology, music, startups, sports, film, conferences, holidays, business and parties.

Facebook and Google also offer various levels of solicitations for upcoming events.

However, none of these systems offer sharing and socialization around day-to-day events of an individual and his/her social contacts based on electronic calendar interfaces.

Traditional calendars, while providing a reliable and well understood interface for dealing with event attributes like “what,” “when,” “where,” and “who,” do not assist the users with planning and organizing the event. Therefore, there is a need to address the “how,” by assisting users with organization of events through selecting planning tools.

Further, most electronic calendars operate as nothing more than a static repository of events. Most users also maintain private access only to said calendars.

Therefore, it is desirable to provide systems and methods for assisting users to share day-to-day events in a social manner while providing the reliability and flexibility offered by a calendar based system.

Moreover, it is desirable to provide systems and methods facilitating planning of such user events and recommendation of such user events to other users.

### SUMMARY OF THE DISCLOSURE

In accordance with the present disclosure, a computer implemented method for providing user-event based social information over a network is provided. The method includes receiving by the computer, event information related to an operator-defined event comprising an event date and at least one of an event description and an event location, receiving by the computer, a selection of a publication level associated with the operator-defined event, and causing at least a portion of the event information to be displayed within at least one electronic calendar associated with at least one user based on the selected publication level. The publication may be further based on at least one filter policy of the at least one user.

By providing such a computer implemented method, operators are enabled to share day-to-day operator-defined events with whom they would like to share the experience of the associated events with. Such sharing is carried out in the context of a familiar calendar based interface so as to minimize issues associated with learning such a system. Moreover, the ability to share activities and discover activities among existing contacts, for example, within customized social circles, i.e., groups of socially interconnected people, using an open calendar tool can lead to great consumer appeal and more frequent visits to the site.

The causing at least a portion of the event information to be displayed within at least one electronic calendar associated with at least one user may occur without interaction of the at least one user (i.e., no “acceptance” of an event may be involved).

According to some embodiments, the computer implemented method may further include publishing at least a portion of the event information to at least one of an information portal of the operator and an information portal of the at least one user.

Groups may be predefined and/or created and customized by a user as desired. These groups may enable sorting of social contacts and more accurate publication levels for particular events.

Both a private electronic calendar interface and a public electronic calendar interface may be provided for each user of the systems and methods. The result may be an asymmetric sharing model instead of reciprocated friendship model. In other words, users can share one-way with people, but sharing in the other direction is optional. This can aid in protecting the privacy of the users (e.g., shared privacy) and reducing the cost of event discoverability. Further, a group electronic calendar interface may be provided in addition to public and private electronic calendar interfaces to enable viewing and event discovery at the group level.

The computer implemented method may further comprise providing an interface enabling selection of the publication level associated with the user-defined event, for example, friends, everyone, and no publication. Further, the at least one filter policy may be based on at least one of a friend level, a time preference, a location, an ambient condition, a user profile, a custom condition, and an acceptance level.

According to some embodiments, time preference may be selected from at least one of weekdays, weekend days, holidays, daytime, evenings, and work hours. Further, user profiles may comprise information regarding at least one of preferred activities, preferred intervals, preferred location, preferred event size, and preferred weather.

Third-party events may displayed within public and/or private electronic calendars of the at least one user, for example, based on a user profile associated with the at least one user and characteristics of the third-party event. For example, if a user profile is configured to allow third-party event publication when a reduced entry fee is offered, a third-party event offering reduced entry may be published to the user's electronic calendar. According to some embodiments, a fee from at least one third party may be paid to an entity hosting the system in return for such publishing rights.

According to some embodiments, the causing of at least a portion of the event information to be displayed within at least one electronic calendar associated with at least one user is further based on a calculated distance between a geographic location of the at least one user and a location of the operator-defined event.

The computer implemented method may also include providing, by the computer, one or more suggested services based on the event information receiving a selection of the one or more suggested services from the operator and causing references to the one or more suggested services to be displayed on the electronic calendar of the at least one user. Service providers associated with the one or more suggested services based on selection of the one or more suggested services may pay a fee to a host of the system to prioritize their services over other services.

The method may further include generation of a list of recommended events based on, for example, a user profile of the operator. Display of a system recommended event based on at least one of the event information associated with the operator-defined event and an operator profile may then be provided on interfaces associated with the present method. Recommendations can be based on relevance, for example, on attribute overlap between titles, types, time and location, among other things. Event recommendation can occur based on one or more of these attributes, and further upon a total number of current attendees (e.g., those users who have accepted to attend an event).

According to some embodiments, the causing of at least a portion of the event information to be displayed within at least one electronic calendar associated with at least one user can be further based on a weather condition at the event location.

Further, an interface associated with the electronic calendar interfaces can be provided by a third party or implemented within elements of the present system.

According to another aspect of the present disclosure, a system for providing user-event based social information over a network is provided. The system may include a database structured to comprise event information related to one or more operator-defined events, a receiving module configured to receive the event information and a publication level, the event information comprising an event date and at least one of an event description and an event location related to the event, a decision module configured to determine at least one user, based on the selected publication level, and a presentation module configured to cause display of one or more operator-defined events on an electronic calendar. The decision module may be further configured to base the determining on a filter policy of the at least one user.

A client device configured to operate according to the present disclosure may be selected from at least one of a mobile device (e.g., mobile phone, iPod, dedicated internet browser, reader device, etc), a personal computer, a dedicated calendar device, and an interactive photo frame.

Additional objects and advantages of the present disclosure will be set forth in part in the description which follows.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate one or more embodiments of the present disclosure and together with the description, serve to explain the principles of the present disclosure. In the drawings,

FIG. 1A is an illustration showing an exemplary electronic calendar interface including one or more indicators related to event information according to embodiments of the present disclosure;

FIG. 1B is an illustration showing another exemplary electronic calendar interface including one or more indicators related to event information according to embodiments of the present disclosure;

FIG. 2 is a block diagram illustrating an exemplary method for providing user-event based social information over a network;

FIG. 3 is an illustration of an exemplary interface configured for receiving event information according to embodiments of the present disclosure;

FIG. 4 is an illustration of an exemplary service selection interface enabling user selection of one or more services from a subset of available services for incorporation within a user interface following entry of event information;

FIG. 5A is an illustration showing an exemplary user information portal according to embodiments of the present disclosure;

FIG. 5B is an exemplary illustration of a revised version of the user information portal at FIG. 5A following publication of event information;

FIG. 5C is an illustration showing an exemplary user interface for detailing event information according to embodiments of the present disclosure;

FIG. 6 is a block diagram showing an exemplary method for filtering policy regarding one or more user-defined events;

FIG. 7 is an illustration of an exemplary architecture according to embodiments of the present disclosure;

FIG. 8A is a block diagram illustrating an exemplary architecture associated with a client device consistent with embodiments of the present disclosure; and

FIG. 8B is a block diagram illustrating an exemplary architecture associated with a server device consistent with embodiments of the present disclosure.

### MORE DETAILED DESCRIPTION

Reference will now be made in detail to the exemplary embodiments of the present disclosure, examples of which are provided and illustrated in the accompanying drawings. Wherever possible, the same reference numbers will be used throughout the drawings to refer to the same or like parts.

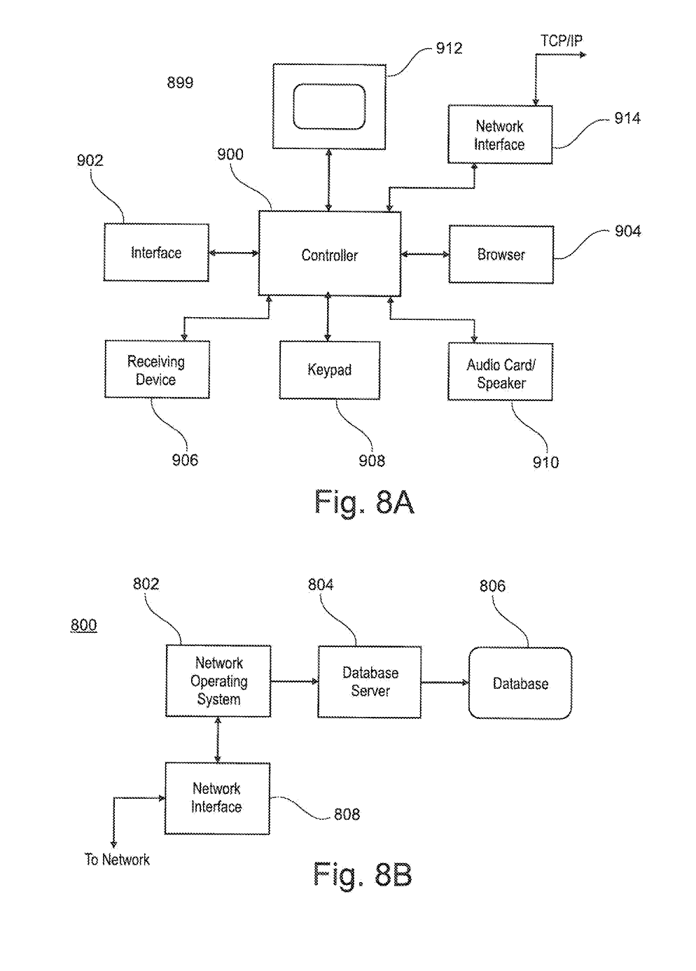

According to exemplary embodiments of the present disclosure, an operator may be enabled to share one or more user-defined events with a selected collection of other users and access public and private calendars or other suitable applications for purposes of editing, storing, sharing, and displaying such event information, and information related thereto. For example, systems and methods of the present disclosure may be accessed on a client device 899 (shown at FIG. 8A) and/or over a network such as a LAN or the Internet via communications with, for example, a server device 800 (shown at FIG. 8B).

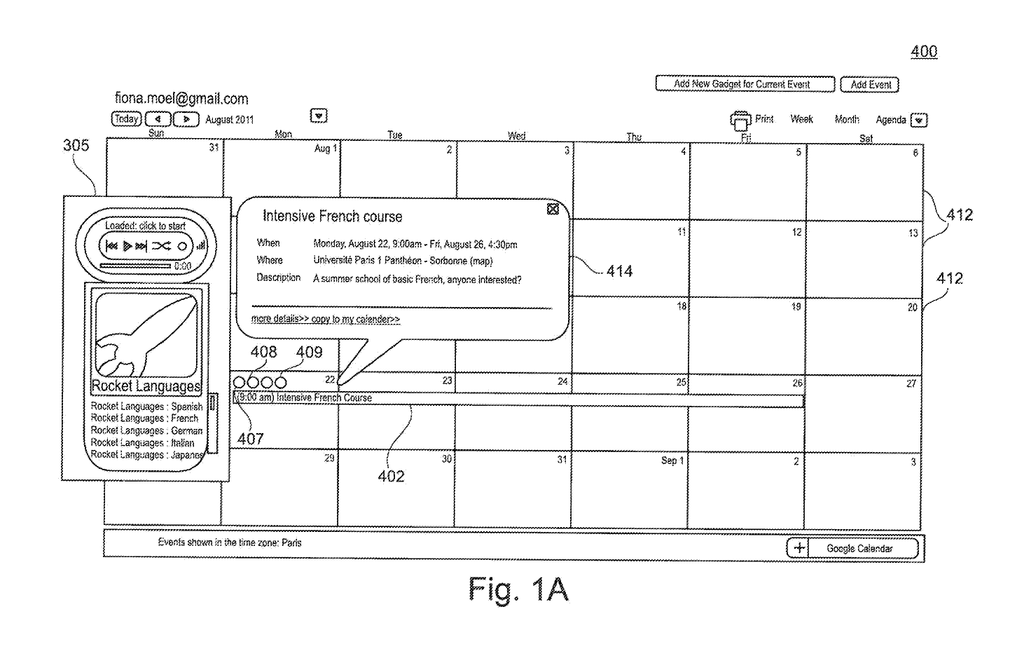

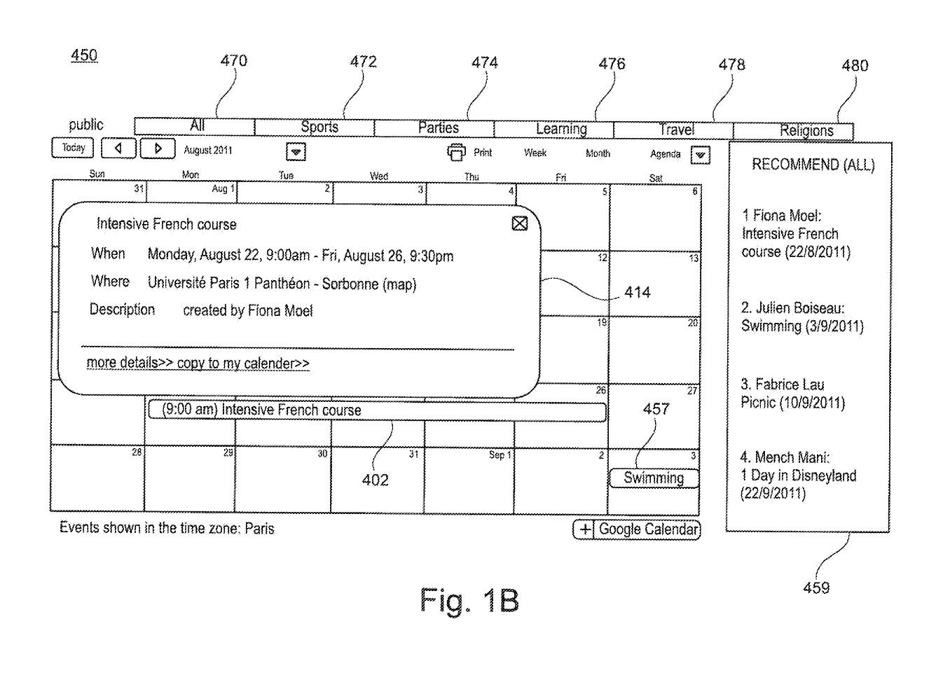

FIGS. 1A and B are illustrations showing exemplary electronic calendar interfaces 400 and 450 for displaying and sharing event information in the context of social networking. Electronic calendar interfaces 400 and 450 include one or more indicators related to event information according to embodiments of the present disclosure. Electronic calendar interfaces 400 and 450 can be configured in a calendar format capable of displaying one or more date representations 412 displaying event information for operator defined events 402, and capable of conveying event information details 414 related to the operator defined event 402. Such interfaces may be useful and intuitive, for example, for clearly depicting to users within a social network of the operator, the time at which an operator defined event is to take place.

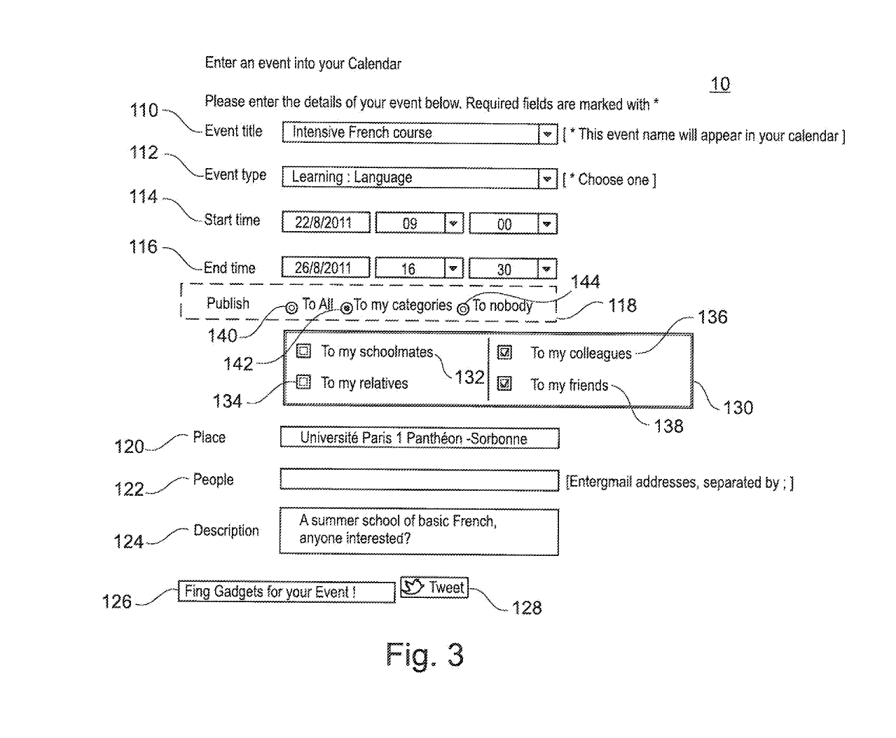

According to embodiments of the present disclosure, an operator may add, edit, or delete one or more user-defined events 402 at any particular date and over a particular time period as desired. For example, a user may select a date and time from electronic calendar interface 400 and be presented with event information interface 10 shown at FIG. 3), enabling further detail input and actions related to the operator defined event.

According to some embodiments, each electronic calendar interface may include five days of the business week (e.g., Monday to Friday), a seven day week (i.e., Monday-Sunday), all days in a month (e.g., thirty days of November), etc. Depending on the number of days displayed, greater or lesser detail may be available to a viewer of electronic calendar interfaces 400 and 450. Thus, according to some embodiments, it may be desirable to provide drill down functionality to enable greater levels of granularity associated with each date representation 412. This may enable greater or fewer events to be viewed depending on the level of granularity.

Private electronic calendar interface 400 may be configured to display those events accepted, scheduled, and/or configured by an operator. The term “operator,” as used herein, shall be interpreted to mean an entity currently logged in and/or otherwise in control of user interfaces according to the present disclosure and, for example, provided at client device 899. In other words, events defined and shared by other users generally may not be displayed on private electronic calendar interface unless an operator of the system were to indicate acceptance of such an event, at which point, such an event may then also be displayed on private electronic calendar interface 400. The term “user,” as used herein, shall thus be interpreted to mean any other entity interacting with the social information of an operator from, for example, a remote client device 899, e.g., someone within the social network of the operator.

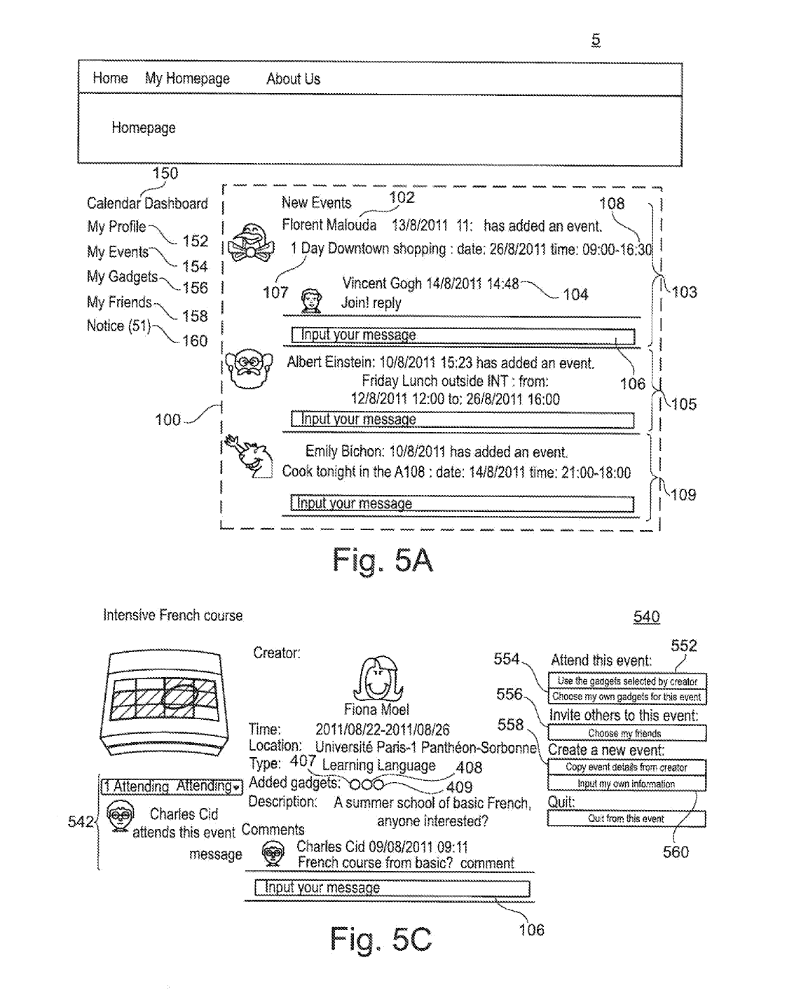

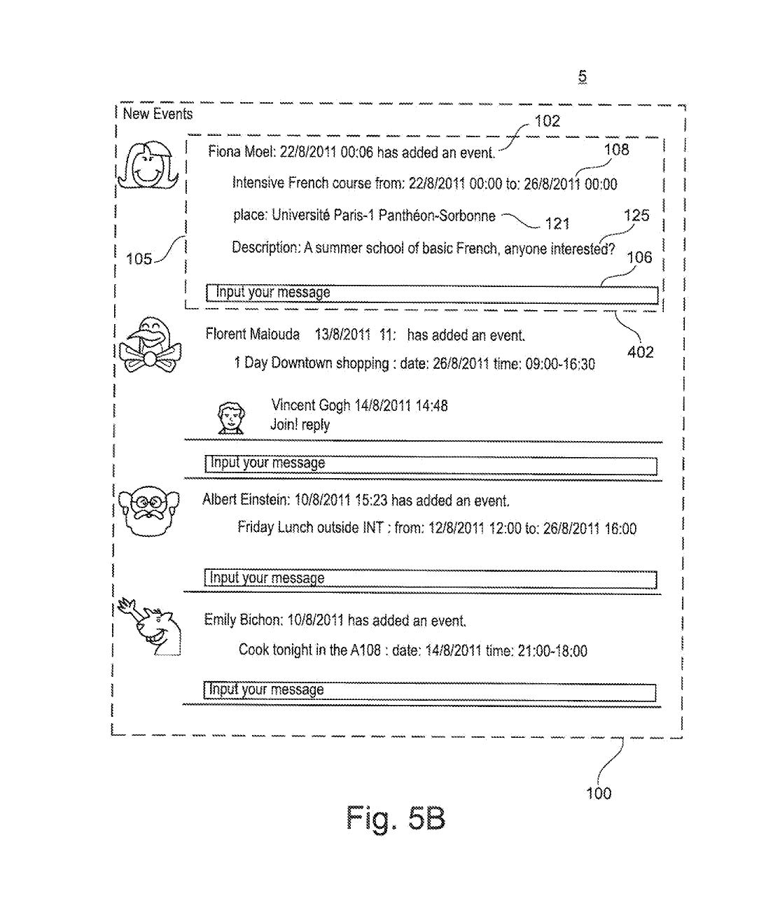

Importantly, public electronic calendar interface 450 may be configured to display event information associated with both the operator (i.e., currently logged in user) and other users within the operator's social network of connections. In other words, while private electronic calendar interface 400 may be configured to display those events accepted and/or configured by an operator, public electronic calendar interface 450 may publish both the operator's events and other events published by users within the social network of the operator. An example of this is shown at FIG. 1B by public event 457, which is not shown in private electronic calendar interface 400, because it has not yet been accepted by the operator. However, the operator, while viewing public electronic calendar interface 450 may notice the public event 457 of her social contact in relation to her own event and see that she has the free time to attend this event. Therefore the operator may access this event to get more information, for example, by clicking on public event 457 in public electronic calendar interface 450. Upon such accessing, the operator may view an information detail interface 540 similar to that illustrated at FIG. 5C, discussed in greater detail below.

Electronic calendar interfaces 400 and 450 may be presented as a flat calendar and/or may be configurable to be displayed with a tabbed type or other suitable interface. According to some embodiments, a collection of tabs 470-480 may be provided to enable viewing of multiple electronic calendar interfaces. For example, an electronic calendar interface may be organized into categorized tabs related to event categories. In such an embodiment, tab 470 may enable viewing of all published events, while tab 472 may display only sporting events, tab 474 party events, tab 476 learning events, tab 478 travel events, and tab 480 religious events. One of skill in the art will recognize that more or fewer tabs may be used as desired. Further, the described tab collection is exemplary only and that different tab collections may be utilized, e.g., groups, publication levels, etc., without departing from the scope of the present disclosure.

Tabs 470-480 may be selected by an operator at will or may be set to display sequentially in a “slideshow” style display. In such an embodiment, each tab may display its contents for a particular period of time (e.g., 10 seconds) before the next tab is displayed. Such a configuration may be particularly useful when displayed on a dedicated calendar device.

Additionally, public electronic calendar interface 450 may be configured to recommend events of other users, for example, via recommendation indicator 459. Recommendation indicator 459 may present a variety of events associated with users within the social network of the operator as well as the user's identifier who has configured the event.

Such recommendations may be based on, for example, a distance between the operator and the user event, user profile preferences of the operator, weather conditions associated with the event location, time of the event, etc. For example, an operator may have configured a user profile indicating that following attendance of a concert, this operator does not want to attend another concert for at least another 7 days. In the case where a user within the social network of the operator has scheduled an event to attend a concert in the week after the operator has attended a concert, the user's concert would not be recommended to the operator. In another example, an operator may configure a user profile to indicate that following an exam, the operator prefers to attend or participate in a sporting event. Therefore, user defined events related to sports for users within the operators social network may be given priority as recommendations at recommendation indicator 459 following (e.g., in the time period after) the operator's indication of an exam event. In yet another example, where a certain threshold number of social contacts (e.g., 10 social contacts) associated with an operator have accepted to attend an event, such an event may be recommended to the operator.

Notably, recommendation indicator 459 may also change recommendations based on a selected tab as described above with regard to tabs 470-480.

One of skill in the art will recognize that numerous such recommendation policies can be implemented within the context of the present disclosure.

In addition to other elements of electronic calendar interfaces 400 and 450, access elements 407-409 may be provided to enable interaction with one or more selected services (e.g., web services, locally hosted services, etc.) selected by a user, to be discussed in greater detail below. Therefore, access elements 407-409 may function as hyperlinks, buttons, and/or any suitable element for indicating selection or actuation of an access element.

Importantly, other electronic calendar interfaces may be provided. For example, while not shown in the figures, a group electronic calendar interface may also be provided. Such an interface may appear and function similarly to public electronic calendar interface 450, but with limited access, i.e., only those users/operators belonging to a particular group may be able to view such a group electronic calendar interface. For example, such a group may be a “friends” group defined by a first operator, and this operator may add certain social contacts within the network to this group. These users may then be enabled to view the group electronic calendar interface among themselves. One of skill in the art will recognize that additional levels of particularity may be provided as desired.

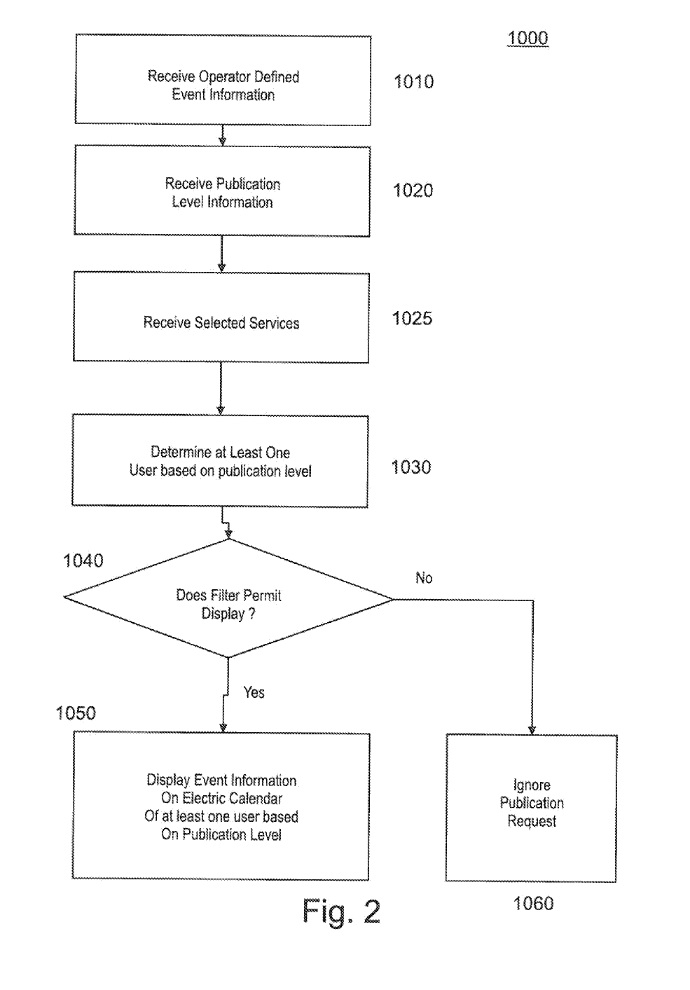

FIG. 2 is a block diagram illustrating an exemplary method for delivery for providing user-event based social information over a network and will be referred to throughout the description, particularly with regard to FIGS. 3-5.

FIG. 3 is an exemplary event information interface 10 enabling information input by an operator related to an operator-defined event including title, type, description, and date and time data. One of skill in the art will recognize that event information interface 10 may include data field textboxes, radio buttons, pushbuttons, checkboxes, tables, and tabs, list boxes, dropdowns, and any other suitable interface element related to input and receiving of event information. Further, one of skill in the art will recognize that such elements may include the associated computer code to provide the desired functionality to such elements.

According to some embodiments of the present disclosure, event information interface 10 may include an event title selector 110 to receive an event title, an event category selector 112 to receive an event category, an event start time selector 114 to receive an event start date, and an event end time selector 116 to receive an event end time.

Further, event information interface 10 may include an event location selector 120 to receive location information, an preferred participant list 122 for indicating particular users of interest to the operator (i.e., those the operator would specifically like to invite), and a description selector 124 enabling entry of a description for the operator defined event. One of ordinary skill in the art will recognize that more or fewer parameters related to an event may be received as desired at step 1010 of FIG. 2.

Each of the elements present within event information interface 10 may receive information in any suitable manner, based on the type of interface element presented by event information interface 10. For example, a user may type information, speak information (speech recognition), click to select information, etc.

Event information interface 10 may be configured to guide a user through the steps of data entry, for example, by providing cues (e.g., visual, audible, locked fields etc.) or otherwise structuring event information interface 10. Further, according to some embodiments of the present disclosure, certain data entry fields may be prefilled based on, for example, a user profile and/or user preferences.

According to embodiments of the present disclosure, an operator provides a start time, an end time, a title, an event category, etc. Event category selector 112 may be provided as a dropdown selector having a pre-filled list of available event categories from which to select one or more event categories for the event. According to some embodiments, such a listing may be filtered based on, for example, other entered data (e.g., the event title) and/or one or more other parameters already existing in the system (e.g., user profile information, user default settings, etc.).

While FIG. 3 illustrates a single dropdown selector as event category selector 112, it may be desirable to provide, for example, multiple dropdown selectors, a list box selector, a checkbox selector, and/or any other suitable elements for selecting more than one event category for a particular event. One of skill in the art will recognize that many occasions may be categorized by more than one event category, and the examples herein are not intended to be limiting.

Event information interface 10 may further include publication level selector 118 for selecting a level of publication for an operator defined event, and group selector 130, which may provide further narrowing of entities intended to view publication of the operator defined event. This information may also be received by the system (step 1020).

It may be desirable to limit and/or avoid publishing an operator defined event to calendars of every social contact associated with an operator. This may be true because, for example, the operator may not wish for some social contacts to see an event when it is, for example, a family or work event.

Therefore, publication level selector 118 may include publication level indicators 140-144, such indicators enabling selection of a publication level for the presently defined event. Publication level indicators 140-144 may enable publication to all social contacts, a collection of social contacts based on group assignment, and no publication at all. One of ordinary skill in the art will recognize that more or fewer publication level indicators may be provided based on a level of particularity desired to be implemented.

In addition to publication level selector 118, group selector 130 may be provided by event information interface 10, to permit a selection of one or more groups defined by the operator and/or the system to be selected as recipients of the operator defined event within their electronic calendar. Group selector 130 may therefore include one or more group indicators 132-138 permitting selection of such groups. For example, an operator may define groups such as, for example schoolmates, relatives, colleagues, friends, etc., and subsequently assign social contacts within the operator's network of social contacts to the groups as defined. One of skill in the art will recognize that any number of groups may be defined by the operator and/or the system, and are intended to fall within the scope of the present disclosure.

In one exemplary scenario, a user may belong to one or more groups, for example, both a schoolmate and a relative. According to some embodiments a user may belong to only one group, based on the desires of the operator. One of skill in the art will understand that such configuration options are within the scope of the present disclosure.

According to some embodiments, group selector 130 may not be visible until a user has actuated a publication level indicator enabling the display of group selector 130, for example category indicator 142. Alternatively group selector 130 may be present and visible while event information interface 10 is displayed. Notably, one of skill in the art understands that any element present within event information interface 10 may be displayed on its own individual screen or within a collection of the elements defining the interface.

According to some embodiments of the present disclosure, the system may be integrated with one or more social networking sites such as, for example, Twitter, Facebook, Google+, etc. In such embodiments, a user may be presented with one or more actuators 128 enabling sharing of the entered information with one or more third-party social networking sites (e.g., Twitter). These actuators may enable publication of the event information entered to be published to the one or more social networking sites, in addition to the electronic calendars 450 and/or information portals 5 of the users based on the publication level.

Event information interface 10 may further provide a services actuator 126 configured to provide access to one or more services related to planning and/or execution of an event and to receive a user's selection thereof (step 1025). In such embodiments, upon actuation of services actuator 126, client device 899 and/or server 800 may analyze the provided event information to provide a subset of system recommended services 305 and to enable the user to select one or more services for providing in conjunction with event information displayed on electronic calendar interfaces 400 and 450, among others.

According to some embodiments of the present disclosure, a computerized database 806 comprising information (e.g., URL, title, etc.) regarding one or more available services may be queried and the results analyzed for generating the subset of system recommended services 305. In such embodiments, the queries used may be dynamically created based on the event information including the event category, among other things.

Alternatively, or in conjunction with the above, the system may also provide a list of previously selected services as available for selection based on, for example, the operator's past preferences. In such an embodiment, where an operator has previously specified a preference for one or more services with regard to a particular event type, the system may again propose those as system recommended services 305.

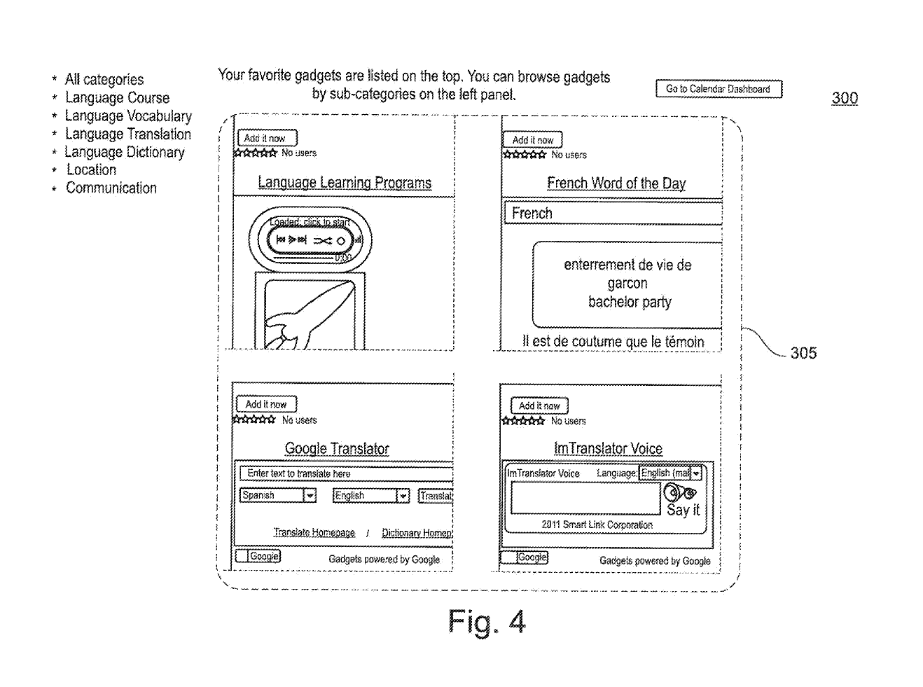

FIG. 4 is an illustration of an exemplary service selection interface 300 enabling user selection of one or more services from a subset of available services for incorporation within a user interface following entry of event information. As can be seen, the available and/or recommended services can be grouped by categories for ease of navigation and selection. For additional information regarding recommendation, selection, and presentation of system recommended services, see U.S. patent application Ser. No. 12/909,898, filed 22 Oct. 2010, the contents of which are hereby incorporated by reference.

Once a user has entered event information related to an operator defined event, including an event category, selected services, a selected a publication level, and, where desired, one or more groups for publication of the event information, the operator entered information may be transmitted to and received by, for example client device 899 and/or server 800. For example, client device 899 may transmit event, publication level, and selected service information to server 800 via a network, such as, for example, the Internet.

Upon receipt of such information, server 800 and/or client device 899 may undertake to analyze the event and publication level information to determine one or more users for which publication on a public electronic calendar interface 450 has been selected (step 1030).

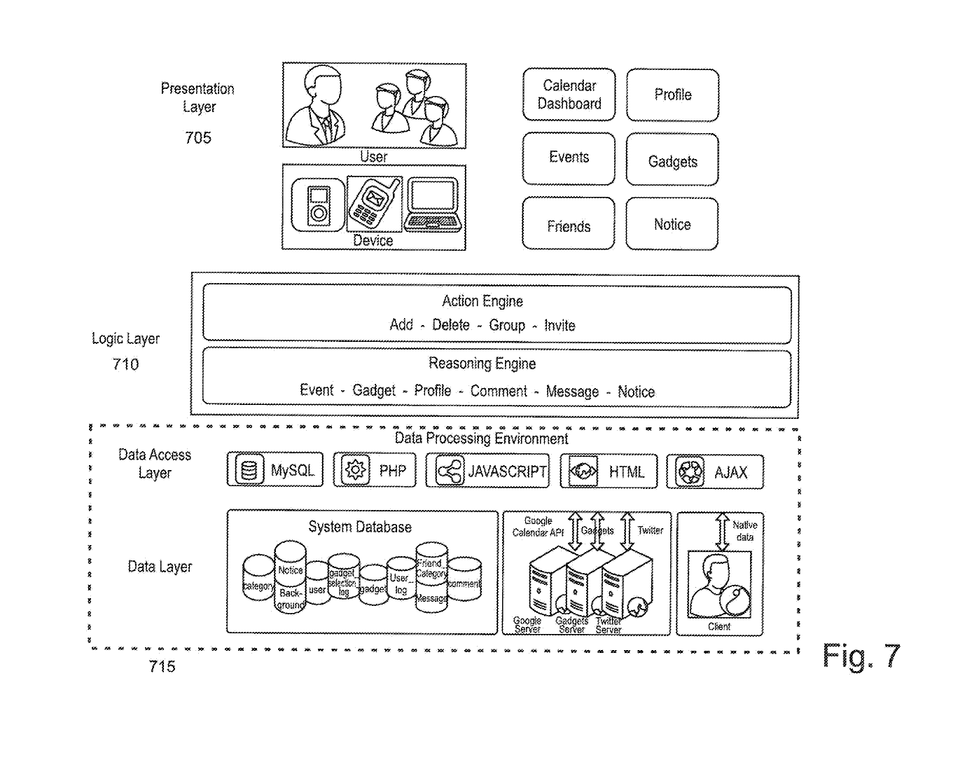

The determination may be made based on the information submitted as previously described. For example, server 800 may query database server 804 to determine users present in groups selected by the operator (e.g., colleagues and friends of the operator). Upon identifying these users, the event information may be published to the electronic calendars and/or information portals 5 of the identified users, provided there is no filter policy of the identified users preventing such publication (step 1040: no).

Where a publication preventing filter policy has been applied by an identified user (step 1040: no), publication of the event information to the public electronic calendar interface 450 of the identified user may not be permitted (step 1060). Alternatively, where no such filter policy has been applied, or where the applied filters do not prevent publication (step 1040: yes) publication may then be carried out (step 1050). Such filtering will be discussed in greater detail below with regard to FIG. 7.

FIG. 5A is an illustration showing an exemplary user information portal 5 according to embodiments of the present disclosure, and is an alternative display for viewing user defined event information in a social networking context.

Information portal 5 may include various elements configured for conveying event information related to a user event to a user. For example, information portal 5 may include navigation links 150-160 and information display 100.

Navigation links 150-160 enable navigation through the system allowing a user to access various pages displaying various information related to, for example, the user, events, services, friends, user profile, notices, and other elements. In such embodiments, calendar link 150 may be used to access a private electronic calendar interface 400 associated with the operator and/or another user, and/or a public electronic calendar interface 450 accessible by all contacts and/or by defined groups. Profile link 152 may cause display of an interface enabling editing of the user profile associated with the operator, or logged in user, this interface possibly being read-only, as desired or based on system privileges and user login. Events link 154 may cause the system to navigate to an interface enabling entry of events and/or review of events previously entered by the operator. Gadgets link 156 may enable navigation to an interface enabling selection and/or prioritization of services to display in association with particular events, and/or those services previously selected by an operator as favorites, for example. Friends link may enable an operator to view and edit a current listing of social contacts within the network of the user. Notices link 160 may cause system to navigate to an information display wherein the operator is provided alerts/notices that may be of interest to the operator.

Within information display 100, various information blocks 103, 105, and 109 may be presented, each displaying information related to events associated with social contacts of the operator, for example. Poster name 102 may display the name of the social contact who is provided event information related to displayed event. Date information 108 may provide information related to the date and time of the scheduled event, while event title 107 may provide an indication of the substance of the event, among others.

In addition to the information presented by the poster of the event, other users, such as the operator, maybe provided with comment interface 106, permitting submission of one or more comments regarding the event information, or other comments, displayed in information blocks 103, 105, and 109. One of skill in the art will recognize that more or fewer information blocks may be provided, and such information blocks may take any desired shape or size, as desired. Further, information blocks may be ordered and/or filtered based on time, poster, and/or other filter criteria as desired by an operator.

FIG. 5B is an exemplary illustration of a revised version of the user information portal 5 at FIG. 5A following publication of event information to user information portal 5. Publication to user information portals 5 may depend on the publication level and/or group selections, or maybe independent thereof. In other words, depending on desired implementation, operator defined events may appear on information portal 5 for all social contacts of the operator regardless of selector publication level, or maybe displayed only for those users also receiving publication of the event information on an associated electronic calendar interface. In addition, users may be enabled to hide and or delete publications of particular operators, as desired.

FIG. 5C is an exemplary event information detail interface 540 for displaying event details according to embodiments of the present disclosure. Event information detail interface 540 may be accessed, for example, from information portal 5 upon actuating a link associated with an event 105, and/or from electronic calendar interfaces 400 and 450 upon actuation various event indicators.

In addition to displaying event information details 414, information detail interface 540 may provide various interface elements enabling functionality related to a particular event presented within event information detail interface 540. For example, upon accessing event information detail interface 540, a user may view a list of attendees 542 who have accepted to attend this event, services associated with the event (e.g., those selected by the defining operator), comments, etc.

Further, a user may select to attend the event, thereby adding it to their private electronic calendar interface 400, by for example, selecting an attend option selector 552 or 554. When making such a selection, the user may decide to use the services selected (as described above) by the operator who coordinated the event (button 552). The user may view the services added by the operator for an event by, for example, hovering and/or clicking on access elements 407-409. Alternatively, the user may decide to select a different collection of services related to the event (button 554).

Moreover, the user may invite his or her own social contacts (button 556) to the presently viewed event and/or create a new event from the details displayed at event information detail interface 540 (button 558), i.e., without have to retype the entire event, or create a completely new event (button 560) for which details will be entered, publication level selected, and services selected.

Any of the interfaces described with regard to FIGS. 5A-C may be implemented to provide “blog” style functionality, such that users may be enabled to socialize online regarding the event. In other words, comments, attendance, and details, among others may all be discovered, critiqued, and communicated to other users.

Filtering of published user events may provide operators a way to limit the number of events displayed within public electronic calendar interface 450, recommendation indicator 459, and information portal 5, among other things. Such filtering may be configured by an operator based on numerous policies, several examples of which will be described herein, with one of ordinary skill in the art understanding that other such policies may be implemented without extending beyond the scope of the present disclosure.

For example, an operator may configure a user profile specifying elements, including, for example, friend level (e.g., friends, friends of friends, everyone), preferred event days and times (e.g., weekday, weekend; working hours, evening), maximum desired travel distance, preferred weather or location, preferred and/or disfavored events following another event type, acceptance of third-party events, and general interests, among other things.

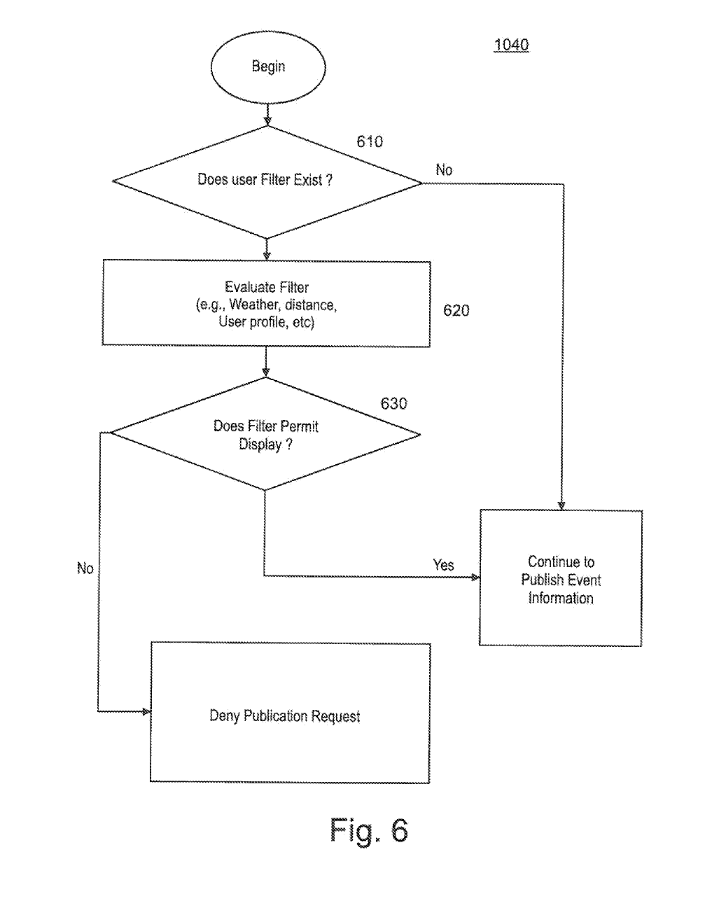

FIG. 6 is a block diagram 1040 showing an exemplary method for filtering policy regarding one or more user-defined events according to the present disclosure. Upon determining a user based on a publication level of an event defined by an operator, the system may determine if the user has configured any filter policies to be applied to an incoming event publication request (step 610). If the user has not applied any filters to the user account (step 610: no) the event information is then published to the appropriate interfaces of the user (e.g., public electronic calendar interface 450, information portal 5, recommendation indicator 459, etc).

Where a user has configured one or more filters, based on, for example, the above-described criteria (step 610: yes), the system evaluates the filter policies configured by the user identified for publication (step 620).

For example, a user may have specified that they are willing to travel a maximum of 30 minutes to an event based on a home and/or a geolocalized position of the user. Therefore, the system may determine a travel time associated with the event based on a position of the user, for example, by GPS geolocalization of a mobile communication device (step 620) known to belong to the user. If the travel time is calculated to be greater than 30 minutes from this location (e.g., or within a predefined tolerance) the event is not published to the identified user (step 630: no). However, if the system calculates a travel time within the specified preferred time of the user, publication is permitted to the user's public electronic calendar interface 450 (step 630: yes), and possibly to information portal 5 and recommendation indicator 459.

One of skill in the art will recognize that variations of filter policy may be implemented within the scope of the present disclosure. For example, a user may be enabled to set a preference for after working hours, for example, “find a party near me.” In such a scenario, the user may elect to be notified of parties based on geolocalization (e.g., via GPS data from a mobile client device 899). The user may then travel around an area with, for example, mobile client device 899 while GPS information is transmitted from client device 899 to update the location of the user. In this way, the user may then be alerted to parties published by social contacts within the user's network and within the current area.

In another example of filtering policy, a user may configure policy based on a friendship level. These levels may include, for example, close friend, friend, acquaintance, friends of friends, everyone, etc. A filter policy based on one of these levels may prevent publication of any event published by another user who is not at or above the level of friendship, e.g., a filter policy set for “friend” may only permit publication of close friend and friend events, to the exclusion of acquaintance, friends of friends, and everyone.

In yet another example of filtering policy, a user may configure a user profile with preferred activities (e.g., golf) and preferred intervals between such activities (e.g., 1 week). In such an example, if the user has scheduled and participated in a round of golf and another user in the social network schedules a golf outing event within the week, such an event may not be published to the user's public electronic calendar interface 450.

One of skill will understand that combinations of such filter policies may also be implemented. For example, if a golf outing was published by a close friend within one week of a previous round of golf in the example above, the user may configure the policy to publish such an event (i.e., events of close friends override interval preferences). However, if the second golf outing was published by an acquaintance, the user may not permit publication because such a friendship level may not override interval preferences.

Some of these filtering policies may be automatically implemented by the system. For example, the system may be configured to presume that an operator is unwilling to participate in a user event being held in Paris, France in 5 hours when the operator is currently located on the west coast of the United States. Therefore, such a filter may act to prevent publication to the operator's public electronic calendar interface 450, while, for example, still publishing to the operator's information portal 5. Alternatively, no publication at all may occur.

FIG. 7 is a high level illustration of an exemplary logical architecture consistent with embodiments of the present disclosure. Such a system may be implemented by logically maintaining a presentation layer 705, a logic layer 710, and a data layer 715. Software and/or hardware modules associated with presentation layer 705 may be configured to generate and provide data causing display of interfaces (e.g., electronic calendar interfaces 400 and 450), issue queries requesting information (e.g., users based on publication level), and receive user selections and data from a client device 899, for example, via a network.

Software and/or hardware modules associated with logic layer 710 may be configured to interface and provide communication with database 806, among other things. For example logic layer 710 may perform queries against database 806 (e.g., to retrieve a list of social contacts based on a publication level, etc.) and perform operations to check filter policies, among other things, based on information from presentation layer 705.

Software and hardware modules associated with data layer 715 may be configured to provide database and communication services, among others. For example, data layer 715 may comprise database server software, as well as web server software configured to transmit data (e.g., HTML, PHP, JavaScript, etc.) causing display of one or more interfaces on a client device (e.g., user interface 100).

An exemplary computer system consistent with the present disclosure is now described with reference to FIGS. 8A-B. FIG. 8A is a block diagram of an exemplary client device 899 consistent with embodiments of the present disclosure. While elements of FIG. 8A are illustrated to highlight components of exemplary client device 899, one of ordinary skill in the art will recognize that client device 899 may be of any suitable size with more or fewer components as desired. Further, while the components of FIG. 8A are shown as logical devices, one skilled in the art would readily understand that each can be associated with a respective physical device. For example, as described in the foregoing description, client device 899 may comprise a personal computer (e.g., a laptop or desktop computer), a mobile device (e.g., a mobile phone, a tablet computer, a reading appliance, etc.), a dedicated calendar device, an interactive picture frame, or any suitable device providing desirable functionality based on embodiments of the present disclosure.

Client device 899 may include any suitable operating system, for example, Windows, Mac OS, iOS, Android, LINUX, UNIX, etc. Such operating systems may be proprietary to a manufacturer of client device 899, proprietary in general, open source, or any combination thereof.

It will be understood by those skilled in the art that communication via a network may take place using a single or a combination of protocols and technologies. For example, communication may take place over Hypertext Transfer Protocol (HTTP) and Transmission Control Protocol/Internet Protocol (TCP/IP) for transport and Hypertext Markup Language (HTML), PHP, JavaScript, and PHP for presenting information to users. Further, where available, communication may take place using any combination of additional transport layers including, for example, Global System for Mobile Communications (GSM) and/or Universal Mobile Telecommunications System (UMTS) alone or in combination with other protocols for transmitting information.

Client device 899 may be configured to receive information and/or requests from users, display information to users, and communicate with one or more devices via, for example, a wired and/or a wireless network. As shown, client device 899 may include a controller 900, a storage interface 902, a browser 904, a receiving module 906, a keypad 908, an audio card/speaker module 910, a video display 912 (e.g., including touch screen capability), and a network interface 914.

Controller 900 may include a processor and/or memory. Storage interface 902 may provide access to and/or may include one or more software applications stored in local storage which may be configured for displaying graphics to provide information to a user.

For example, instructions associated with browser 904 may be stored or otherwise accessible via storage interface 902. Browser 904 may include any suitable software application, such as, for example, Microsoft Internet Explorer, Mozilla Firefox, Google Chrome, Opera, Apple Safari, or any other suitable software for issuing HTTP requests and receiving HTTP responses over network 100. For example, browser 904 may be configured to request a specific web page such as, for example, a network based user calendar. Browser 904 may also read HTML codes embedded in the web pages received from server 800 to determine how, where, and in what colors and fonts the elements on the web pages may be displayed.

Receiving device 906 may be combined with or used in combination with keypad 908 and network interface 914 for purposes of receiving information from a user or a network, among others. Receiving module 906 may comprise both hardware complements as well as software modules for enabling receipt of information, for example event information.

Keypad 908 may comprise a conventional alphanumeric or numeric key entry device. Keypad 908 may, for example, permit a user to enter, for example information related to one or more events. According to some embodiments, a keypad may not be necessary because a user may be able to input information using touch screen capabilities of video display 912, voice recognition software, or other suitable entry methods.

Audio card/speaker module 910 may comprise a conventional audio card, amplifier, and speaker for presenting audio.

Display device 912 may comprise a conventional video display (e.g., CRT, LCD, LED, etc.) for displaying video graphics and receiving (e.g. touch-screen functionality) user input. According to some embodiments, touch-screen functionality may not be present, and user inputs may be made through keypad 908.

Network interface 914 may comprise any suitable interface for transmitting and receiving information over a network. For example network interface 914 may comprise a wireless interface (e.g., WiFi 802.11(x), GSM, etc.) and/or a wired interface (e.g., USB, RJ45, etc.) Network interface 914 may be configured to transmit requests from, for example, browser 904 and to receive responses via a network (e.g., the Internet). For example event information, service information, and other desirable data (e.g. user interface data) may be transmitted via network between a client device and a server device.

Although not shown, user client device 899 may include a printer device to print information. Moreover, user client device 899 may also include other input devices, such as a pointing device (e.g., trackball or mouse). In addition, user client device 899 may also include head phones, for example, to listen to audio, and text-to-speech and/or speech-to-text conversion software, respectively, to listening to and/or to speak information.

FIG. 8B is a block diagram of an exemplary server 800 consistent with the present invention. As shown, server 800 may include network operating system 802, a database server 804, one or more databases 806, and a network interface 808. Network operating system 802 may include any conventional or future developed operating system (e.g., DOS, Linux, Windows, VMS, VAX, BeOS, Solaris, OS/2, Macintosh, UNIX, etc.). Similar to network interface 914, which was described above in connection with FIG. 8A, network interface 908 may transmit information to and receive information from client devices 899 via any suitable network protocol or combination of protocols.

Database server 804 may provide access to and maintain database 806. In addition, database server 804 may retrieve from database 806 event information, service information, user interface, and other information responding to requests from the client devices 899. Furthermore, the database server 804 may include any suitable database management software, for example, SQL Server, Oracle, MySQL, etc. Database 806 may store user account files, client terminal files, graphical menus, event information, available services, and other multimedia information.

Database 806 may include event hierarchy information, service information, user information, calendar information, and any other suitable information for implementing systems and methods of the present disclosure. While database 806 has generally been referred to in the singular, database 806 may comprise one or more databases. For example, a first database may comprise categories, a second database comprising available services, a third database comprising user information (e.g., use profiles), and a fourth database comprising a service selection history. One of skill in the art will recognize that such examples are not intended as limiting, and database 806 may be configured as desired.

Server 800 may also include storage devices configured to store various code modules comprising instructions, which when executed cause server 800 to perform functions consistent with embodiments of the present disclosure. Software modules may be developed for carrying out various tasks associated with the methods described herein. For example, such modules may include a receiving module, a selection module, a determining module, a publication module and a user interface module, and may be developed using objected oriented and/or other development techniques, and using Java, C, C++, BASIC, and/or any suitable programming language. One of skill in the art will recognize that many programming languages exist and likely more will be developed in the future. Therefore, the scope of the present disclosure is not intended to be limiting to any one programming language mentioned herein.

Receiving module may be configured to receive event information from an operator, the event information comprising an event date, an event category, and a publication level related to the event, determining module may be configured to determine one or more users who should receive publication to their public calendars of event information, selection module may be configured to receive a selection of one or more groups and services associated with the event, among others.

Publication and user interface modules may be configured to publish event information to electronic calendars of one or more users based on the publication level of the event information and/or a filter policy of the one or more users. Such publication and display my comprise generation of user interface data causing display of a user interface comprising at least a portion of the event information on an electronic calendar of a user.

Notably, the software modules described herein are intended as exemplary only, and may be fewer or greater as desired. Moreover, such software modules may be present on server 800, client device 899, a separate device, or any combination thereof.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within generally accepted manufacturing or industry tolerances, and any use of the terms “substantially” and/or “approximately” should be understood to mean falling within such generally accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the present disclosure herein has been described with reference to particular embodiments, it is to be understood that these embodiments are merely illustrative of the principles and applications of the present disclosure. For example, a user may configure filter policies and/or user profiles to allow or otherwise agree to receive suggested events from a third-party provider. For example, such a user may find events not only from within his or her social network posted to the public electronic calendar interface, but also events sponsored and/or organized by a third-party. In return, the user may receive some form of remuneration, for example, a discounted entry price and/or free gift items, among others.

It is therefore to be understood that numerous modifications may be made to the illustrative embodiments and that other arrangements may be devised without departing from the spirit and scope of the present disclosure as defined by the appended claims.

What is claimed is:

1. A computer implemented method for providing user-event based social information over a network, the method comprising:
receiving by the computer, event information related to an operator-defined event comprising an event date and at least one of an event description and an event location;
receiving by the computer, a selection of a publication level associated with the operator-defined event; and
causing at least a portion of the event information to be displayed within at least one electronic calendar associated with at least one user based on the selected publication level.

2. The computer implemented method of claim 1, wherein the causing at least a portion of the event information to be displayed within at least one electronic calendar associated with at least one user occurs without interaction of the at least one user.

3. The computer implemented method of claim 1, wherein the causing at least a portion of the event information to be displayed within at least one electronic calendar associated with at least one user is further based on a filter policy of the at least one user.

4. The computer implemented method of claim 1, further comprising publishing at least a portion of the event information to at least one of an information portal of the operator and an information portal of the at least one user.

5. The computer implemented method of claim 1, further comprising providing an interface enabling selection of the publication level associated with the operator-defined event.

6. The computer implemented method of claim 1, wherein available publication levels include selected groups, everyone, and no publication.

7. The computer implemented method of claim 6, wherein the selected groups are operator configured.

8. The computer implemented method of claim 3, wherein the filter policy is based on at least one of a friend level, a time preference, a location, an ambient condition, a user profile, a custom condition, and an acceptance level.

9. The computer implemented method of claim 8, wherein the time preference is selected from at least one of weekdays, weekend days, holidays, daytime, evenings, and work hours.

10. The computer implemented method of claim 8, wherein the user profile comprises at least one of preferred activities, preferred intervals, preferred location, preferred event size, and preferred weather.

11. The computer implemented method of claim 1, wherein a third-party event is displayed within the electronic calendar of the at least one user based on a user profile associated with the at least one user and characteristics of the third-party event.

12. The computer implemented method of claim 1, wherein the causing at least a portion of the event information to be displayed within at least one electronic calendar associated with at least one user is further based on a calculated distance between a geographic location of the at least one user and a location of the operator-defined event.

13. The computer implemented method of claim 1, further comprising:
providing, by the computer, one or more suggested services based on the event information;
receiving a selection of the one or more suggested services from the operator; and
causing references to the one or more suggested services to be displayed on the electronic calendar of the at least one user.

14. The computer implemented method of claim 10, further comprising receiving a fee payment from at least one service provider associated with the one or more suggested services based on selection of the one or more suggested services.

15. The computer implemented method of claim 1, further comprising causing display of a system recommended event based on at least one of the event information associated with the operator-defined event and an operator profile.

16. The computer implemented method of claim 15, wherein the system recommended event is further based on total number of current attendees.

17. The computer implemented method of claim 10, wherein the causing at least a portion of the event information to be displayed within at least one electronic calendar associated with at least one user is further based on a weather condition associated with the event location.

18. The computer implemented method of claim 1, wherein an interface associated with the electronic calendar is provided by a third party.

19. A system for providing user-event based social information over a network, the system comprising:
a database structured to comprise event information related to one or more operator-defined events;
a receiving module configured to receive the event information and a publication level, the event information comprising an event date and at least one of an event description and an event location related to the event;
a decision module configured to determine at least one user, based on the selected publication level of the at least one user; and
a presentation module configured to cause display of one or more operator-defined events on an electronic calendar.

20. The system of claim 16, wherein the decision module is further configured to determine at least one user based on a filter policy of the at least one user.

21. The system of claim 16, further comprising a client device selected from at least one of a mobile device, a personal computer, a dedicated calendar device, and an interactive photo frame.
